(19) United States
(12) Patent Application Publication
(10) Pub. No.: US 2009/0187463 A1
(43) Pub. Date: Jul. 23, 2009

(54) Personalized Location-Based Advertisements

(75) Inventor: Behram DaCosta, San Diego, CA (US)

Correspondence Address: CROWELL & MORING LLP;INTELLECTUAL PROPERTY GROUP, P.O. BOX 14300, WASHINGTON, DC, 20044-4300, US

(73) Assignees: SONY CORPORATION, Tokyo (JP); SONY ELECTRONICS INC., Park Ridge, NJ (US)

(21) Appl. No.: 12/016,827

(22) Filed: Jan. 18, 2008

(51) Int. Cl. G06F 17/00; G06Q 30/00

(52) U.S. Cl. 705/10; 705/14

(57) ABSTRACT

Advertising content is selected and provided to a mobile device user based on user location information in combination with user profile information. In one embodiment, user location information and user profile information is provided to an advertisement server over a network connection. An advertisement database lookup operation may then be performed based on current location information for the mobile device, in combination with the aforementioned profile information. The result of this lookup operation is to identify the available advertisements that are most likely to be of interest to the user at the current time.

### FIELD OF THE INVENTION

The present invention relates generally to providing location-based advertisement content, and more particularly to providing location-based advertisement content to mobile device users based on user profile information.

### BACKGROUND OF THE INVENTION

Mobile devices, such as personal digital assistants (PDAs), cellular telephones, smartphones, etc., have enjoyed dramatic increases in popularity in recent times with wireless carriers continually offering new services and content to their mobile subscribers, such as online gaming, Internet browsing, online shopping and social networking.

In the advertising industry there is an ever-present desire to reach potential consumers in new and more effective ways. To that end, advertisers have begun to appreciate the need to reach mobile device users, particularly given that such users are reachable wherever they may be and at virtually any time. However, while such users may be easily reachable, there is a concern that unwanted or irrelevant advertisements may result in a negative reaction from consumers who have grown accustomed to using their mobile devices without the intrusions of advertisements. Thus, while there have been some efforts to push advertising content to mobile device users, such efforts have failed in large part to their inability to provide sufficiently personalized advertising content. The data suggests that the more relevant and directed the advertisement, the less likely it is to be viewed as an annoyance to the consumer. Accordingly, there is a need for a way to provide more directed and personalized advertising content to mobile device users.

### SUMMARY OF THE INVENTION

Disclosed and claimed herein is a method and server for providing advertising content to a mobile device. In one embodiment, a method includes receiving current location information for the mobile device over a wireless network connection, accessing user profile information corresponding to a user of the mobile device, performing an advertising database lookup based on the current location information and the user profile information, and selecting advertising content based on the advertising database lookup. The method further includes transmitting the advertising content to the mobile device over the wireless network connection.

Other aspects, features, and techniques of the invention will be apparent to one skilled in the relevant art in view of the following description of the exemplary embodiments of the invention.

### BRIEF DESCRIPTION OF THE DRAWINGS

FIG. 1 illustrates a communication system in accordance with an embodiment of the invention;

FIG. 2 illustrate a process performed by a mobile user device in accordance with an embodiment of the invention;

FIG. 3 illustrates a process performed by an advertisement server in accordance with an embodiment of the invention; and

FIG. 4 illustrates another process performed by an advertisement server in accordance with an embodiment of the invention.

### DETAILED DESCRIPTION OF THE EXEMPLARY EMBODIMENTS

### Overview of the Disclosure

The present disclosure relates generally to selecting and presenting advertising content to a mobile device user based on user location information in combination with user profile information. In certain embodiments, user profile information may be received during a signup process, or alternatively based on the user's online activities.

One aspect of the invention is to provide user location information for a given mobile device to an advertisement server over a network connection. Additionally, user profile information, corresponding to the historical online activities of the mobile device's user, is also provided to the advertisement server. In one embodiment, the user profile information may also include historical location information for the given mobile device.

Another aspect of the invention is to use current location information, in combination with profile information, to perform a database lookup for the most relevant advertising content available. In one embodiment, this database lookup operation may comprise a two-step filtration operation of an advertising database based first on the user profile information, and then on the user's current location information. In this fashion, advertisements that are most likely to be of interest to the user at the current time may be selected and provided to the user's mobile device.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive. Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, a fiber optic medium, a radio frequency (RF) link, etc.

### Overview of an Exemplary Online Environment

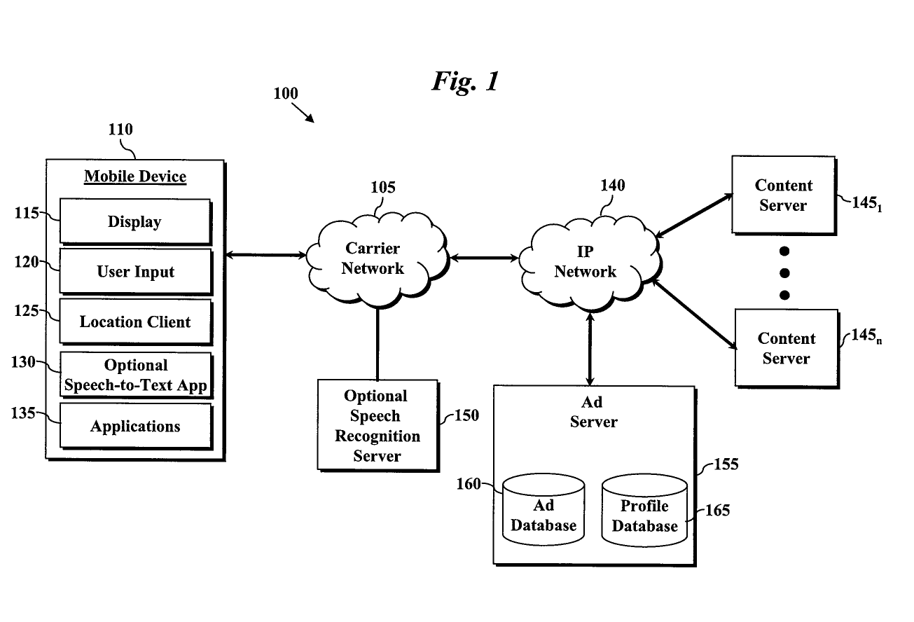

FIG. 1 depicts a communication system 100 in which one or more aspects of the invention may be implemented. In particular, communication system 100 is depicted as including a carrier network 105 which provides wireless communications services to at least one mobile device 110. The carrier network 105 supports at least one wireless communications protocol such as Global System for Mobile communications (GSM), General Packet Radio Service (GPRS), Code Division Multiple Access (CDMA) or Wideband CDMA (WCDMA). The mobile device 110 may be any electronic device adapted to communicate with the carrier network 105, such as a cellular telephone, smartphone, personal digital assistant (PDA), handheld computer, etc.

The mobile device 110 includes a display 115, a user input 120 and a location client 125, which in one embodiment comprises one or more software modules configured to determine and process location information, such as global positioning system (GPS) information. While in one embodiment, the display 115 may be a liquid crystal display (LCD), it should equally be appreciated that any other type of display consistent with the principles of the invention may be used. The user input 120 may include one or more buttons or keys in the form of a keypad, number pad, keyboard or any other collection of individual keys, buttons or the like. In another embodiment, the user input 120 may be integrated with the display 115 in the form of a touch screen. In a typical embodiment, the mobile device 110 will be a resource-limited device, with limited processing and/or data storage capabilities.

Continuing to refer to FIG. 1, the mobile device 110 is further depicted as including an optional speech-to-text application 130, which may comprise one or more software modules configured to parse a user's spoken input, and convert such spoken input to text. Additionally, the mobile device 110 further comprises one or more additional applications 135, which may include any known mobile device software application, such as a browser application, email client, text message client, etc.

Communication system 100 further includes an Internet Protocol (IP) network 140 providing communication paths between the mobile device 110, content servers 145₁-145ₙ and advertisement server 155. While FIG. 1 depicts carrier network 105 as being separate and distinct from the IP network 140, it should equally be appreciated that the functionality provided by the carrier network 105 and IP network 140 may be provided by a single network, or may be operated and managed by a single carrier, or as part of a larger collection of individual networks. With respect to the IP network 140, it should be appreciated that it may be based on any other packet-based networking technology.

System 100 further includes an optional speech recognition server 150, which may be used instead of, or in addition to, the aforementioned optional speech-to-text application 130 in order parse users' spoken input into the text-based equivalent.

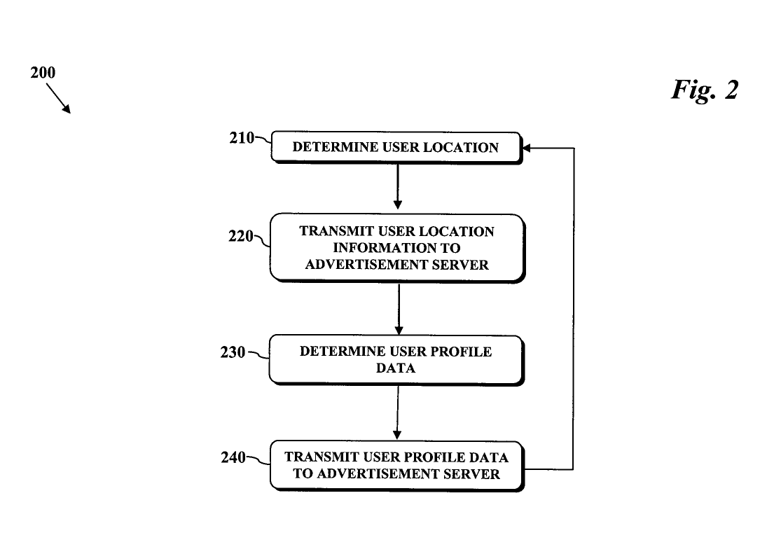

Content servers 145₁-145ₙ may include any server capable of providing online content over IP network 120, including audio content, video content, streaming media, music, gaming-based content, transaction-based content (e.g., online purchasing), text-based content, graphics-based content and any combination thereof. In addition, advertisement server 155 may be configured to provide advertising content to the mobile device 110, as will be described in more detail below with reference to FIGS. 2-4. Advertisement server 150 may be a single server or a collection of servers.

In one embodiment, advertising server 155 may include a profile database 155 or collection of databases configured to maintain user profile information for a plurality of users (e.g., user of mobile device 110). For example, the profile database may maintain profile information associated with a given mobile user's online activities. Such profile database 155 may include a collection of individual demographic characteristics, such as age, social class, gender, race, income, educational attainment, home ownership, employment status, etc. In addition, such user profile information may include historical location information provided by the mobile device 110 using, for example, the location client 125. In addition, the user profile information may include any online habits a user, such as browsing habits, emailing or texting habits, etc. It should further be appreciated that such profile information may be based on communications made by the user, including the content of emails and text messages, as well as the content of spoken communications that have been converted to text using the speech-to-text application 130 and/or the speech recognition server 155. While the profile database is shown as being integrated with the advertisement server, it may alternatively be integrated with a separate server that is also coupled to the IP network 120.

In addition to the profile database 165, advertising server 155 may further include ad database 160 which, in one embodiment, may include advertising content to be served to user devices, such as mobile device 110. Such advertising content may include audio advertisements, video advertisements, text-based advertisements, graphics-based advertisements and any combination thereof.

Referring now to FIG. 2, depicted is a process 200 for implementing one embodiment of the invention using a mobile device (e.g., mobile device 110) in communication with an advertisement server (e.g., ad server 155) over a wireless network connection (e.g., carrier network 105 and/or IP network 140). In one embodiment, process 200 may be carried out using one or more software modules executing on the mobile device (e.g., application 135). In any event, process 200 begins with a determination of the user's current location at block 210. In one embodiment, the user's current location may be determined using the device's GPS functionality provided by a GPS transceiver and a location client (e.g., location client 125). Process 200 may then continue to block 220 where the location information determined at block 210 may be transmitted to an advertisement server over the wireless network connection. In one embodiment, the location information may comprise standard coordinate information, while in other embodiments the location information may be based on any other location metric (e.g., zip code, area code, city, county, etc.)

Process 200 may then continue to block 230 where user profile data may be determined. Such user profile data may include music or video downloading history/habits and/or online purchase history/habits. The spectrum of possible online actions usable to infer profile data may further include a subject user's history or habits for browsing, emailing, texting, social interacting, fantasy sports activities, auctions, personals, navigation and news selection. Essentially, the forms of user activities that can be used to infer profile data are as varied as the types of activities which can be catalogued in a user profile.

Another example of user profile information may be based on user communications, including the actual content of emails and text messages. Such communications may be parsed by an application executing on the mobile device (e.g., one of applications 135), or alternatively on the advertisement server (e.g., ad server 150). In either case, one or more keywords may be transmitted, as profile data, to the advertising server for updating the given user's profile information. Similarly, spoken communications may be converted to text (e.g., using the speech-to-text application 130 and/or the speech recognition server 155 of FIG. 1), with the parsed data being forwarded to the advertisement server.

Continuing to refer to FIG. 2, once the user profile information has been determined at block 230, it may be transmitted to the advertisement server at block 240. Process 200 may then loop back to block 210 where updated user location information may be determined. In this fashion, a user profile and location history may be updated and maintained by a central advertising server, in accordance with the principles of the invention.

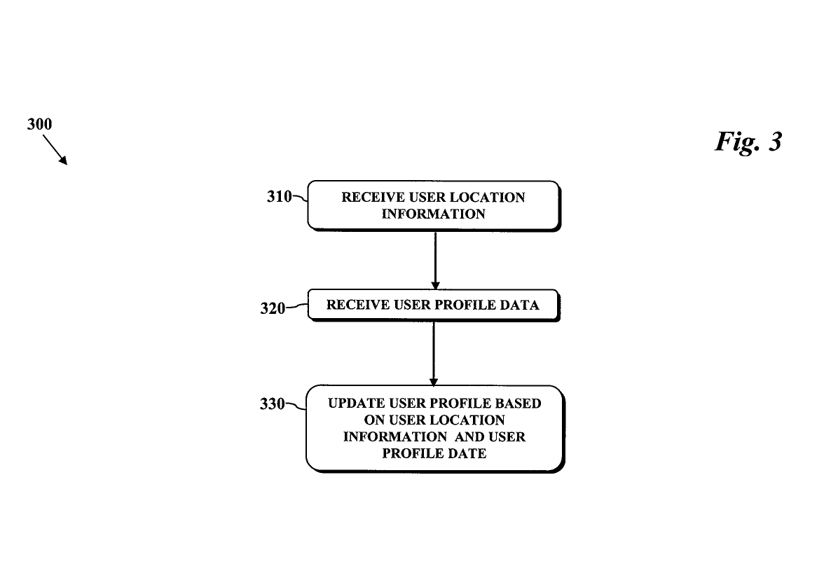

Referring now to FIG. 3, depicted is another process 300 for implementing one embodiment of the invention. In particular, process 300 may be carried out by an advertisement server (e.g., ad server 155) in communication with a plurality of mobile devices (e.g., mobile device 110) over a network connection (e.g., carrier network 105 and/or IP network 140). Beginning at block 310, process 300 includes receiving user location information, which in one embodiment may be the location information transmitted at block 220 of FIG. 2. Process 300 may then proceed to block 320 where user profile information may be received. In one embodiment the user profile information received at block 320 may correspond to the user profile information transmitted during process 200 at block 240. In any event, such user profile data may include any online activity engaged in by a user of a mobile device.

Process 300 may then continue to block 330 where a user profile that is associated with a given mobile device, may be updated based on the received user location information of block 310 and/or the user profile data of block 320. In this fashion, a historical record of the user's online habits and physical locations may be maintained.

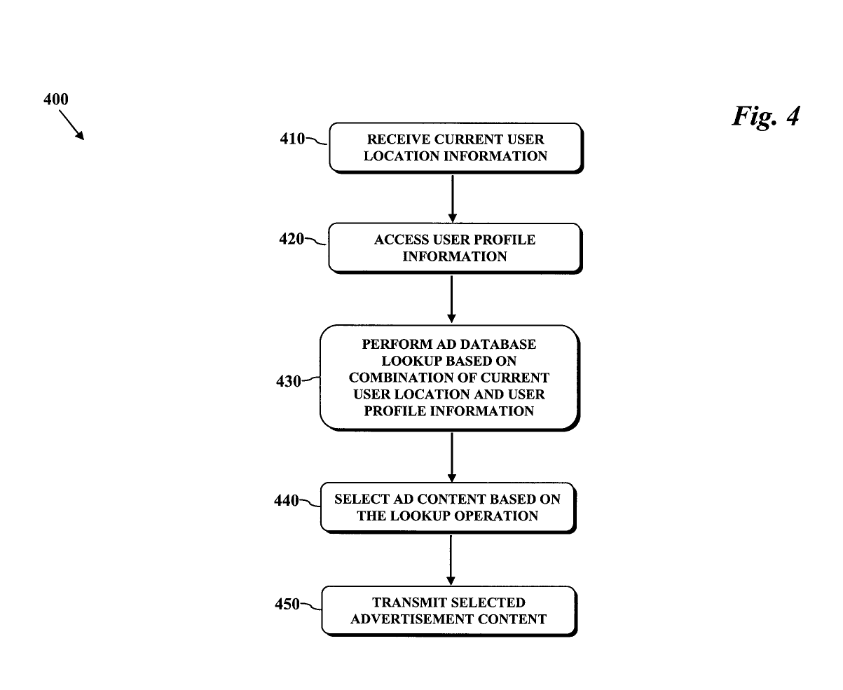

Referring now to FIG. 4, illustrated is one embodiment of a process 400 to be carried out by an advertisement server (e.g., ad server 150) in accordance with the principles of the invention. Specifically, process 400 begins at block 410 with the advertisement server receiving current user location information from a given mobile device (e.g., mobile device 110) over a network connection (e.g., carrier network 105 and/or IP network 140). In one embodiment, this location information may correspond to the location information of process 200 provided by the mobile device at block 220 of FIG. 2.

Upon receiving the location information of block 410, process 400 may continue to block 320 where the user profile corresponding to the given mobile device may be accessed (e.g., from profile database 165). While in one embodiment, this lookup operation may be performed using an identification code transmitted with the location information, it should equally be appreciated that numerous other methods may be similarly employed. For example, a location client (e.g., location client 125) executing on the mobile device may forward the location information to the advertisement server over a persistent connection and/or according to a particular data format.

Once the appropriate user profile information has been accessed at block 420, process 400 may continue to block 430 where a lookup operation of an advertisement database (e.g., ad database 160) may be performed based on a combination of the current location information received at block 410, and the user profile information accessed at block 420. As previously described, the profile information may comprise a historical record of the user's locations, such as areas frequently visited, as well as the user's online habits. Such habits may include such things as music or video downloading, online purchases, browsing, emailing, texting, social interacting, fantasy sports activities, auctions, personals and/or news selection history/habits.

In one embodiment, the database lookup operation of 430 may comprise a two-step filtration operation of the ad database. Namely, the first operation may comprise filtering a pool of all available advertisements based on the user profile information, thereby identifying advertisements that are most likely to be of interest generally for the user in question. Thereafter, a second operation may be performed in which this subset of advertisements may be further filtered based on the user's current location information, and hence identify advertisements that are most likely to be of interest to the user at the current time based on the user's current position.

Based on the results of the lookup operation of block 430, process 400 may continue to block 440 where advertising content may be selected from an advertising database (e.g., ad database 160). As previously mentioned, such advertising content may comprise audio advertisements, video advertisements, text-based advertisements, graphics-based advertisements and any combination thereof.

Process 400 may then continue to block 450 where the selected advertising content may be transmitted over the network connection to the user's mobile device. In one embodiment, the selected advertising content is transmitted over a wireless network connection to a mobile device, such as over carrier network 105 and/or IP network 140 to mobile device 110). In this fashion, the most relevant advertising content may be made available to mobile device users. That is, advertisements that are most likely to be of interest to the user at their current location may be identified and provided to the user.

Although the wireless communications described above with respect to FIGS. 2-4 may occur over one or both of a carrier network and a separate IP network, in some cases only a single network may be used. Similarly, a number of interconnected networks alternatively may be used.

While the invention has been described in connection with various embodiments, it should be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for providing advertising content to a mobile device comprising the acts of:
receiving current location information for the mobile device over a wireless network connection;
accessing user profile information corresponding to a user of the mobile device;
performing an advertising database lookup based on said current location information and said user profile information;
selecting advertising content based on said advertising database lookup; and
transmitting said advertising content to the mobile device over the wireless network connection.

2. The method of claim 1, further comprising receiving user profile data from the mobile device based at least in part on online user activities.

3. The method of claim 2, wherein said online user activities comprise at least one of music downloading, video downloading, online purchasing, web browsing, emailing, texting, social interacting, fantasy sports, personals, navigation and news selection.

4. The method of claim 2, further comprising updating said user profile information using said user profile data.

5. The method of claim 1, wherein said user profile data further comprises historical location data for said mobile device.

6. The method of claim 1, further comprising performing a speech-to-text conversion operation on a verbal communication from said mobile device.

7. The method of claim 6, further comprising updating said user profile information using one or more keywords from said verbal communication.

8. The method of claim 1, wherein selecting advertising content comprises selecting advertising content from a database of available advertisements.

9. The method of claim 1, wherein performing the advertising database lookup further comprises:
identifying a set of personalized advertisements from a pool of available advertisements based on said user profile information; and
identifying a subset of the set of personalized advertisements based on the current location information.

10. The method of claim 9, wherein selecting advertising content comprises selecting one or more advertisement from said subset.

11. An advertisement server configured to provide advertising content over a network, the advertising server comprising:
a network interface configured to connect the server to the;
a memory containing processor-executable instructions for implementing online content selection; and
a processor electrically coupled to the memory, the processor configured to execute the processor-executable instructions to:
receive current location information for the mobile device over the network,
access user profile information corresponding to a user of the mobile device,
perform an advertising database lookup based on said current location information and said user profile information,
select advertising content based on said advertising database lookup, and
transmit said advertising content to the mobile device over the network.

12. The advertisement server of claim 11, wherein the processor is further configured to execute the processor-executable instructions to receive user profile data from the mobile device based at least in part on online user activities.

13. The advertisement server of claim 12, wherein said online user activities comprise at least one of music downloading, video downloading, online purchasing, web browsing, emailing, texting, social interacting, fantasy sports, personals, navigation and news selection.

14. The advertisement server of claim 11, wherein the processor is further configured to execute the processor-executable instructions to update said user profile information using said user profile data.

15. The advertisement server of claim 11, wherein said user profile data further comprises historical location data for said mobile device.

16. The advertisement server of claim 11, wherein the processor is further configured to execute the processor-executable instructions to perform a speech-to-text conversion operation on a verbal communication from said mobile device.

17. The advertisement server of claim 16, wherein the processor is further configured to execute the processor-executable instructions to update said user profile information using one or more keywords from said verbal communication.

18. The advertisement server of claim 11, wherein the processor, in order to select the advertising content, is further to execute the processor-executable instructions to select advertising content from a database of available advertisements.

19. The advertisement server of claim 11, wherein the processor, in order to perform the advertising database lookup, is further to execute the processor-executable instructions to:
identify a set of personalized advertisements from a pool of available advertisements based on said user profile information, and
identify a subset of the set of personalized advertisements based on the current location information.

20. The advertisement server of claim 19, wherein the processor, in order to select the advertising content, is further to execute the processor-executable instructions to select one or more advertisement from said subset.
